(19) United States
(12) Patent Application Publication
(10) Pub. No.: US 2021/0170363 A1
(43) Pub. Date: Jun. 10, 2021

(54) Methods for the Destruction of Contaminants Adsorbed to Activated Carbon

(71) Applicant: Regenesis Bioremediation Products, San Clemente, CA (US)

(72) Inventors: Kristen A. Thoreson, San Clemente, CA (US); Paul R. Erickson, San Clemente, CA (US); Scott B. Wilson, San Clemente, CA (US)

(21) Appl. No.: 17/115,364

(22) Filed: Dec. 8, 2020

Related U.S. Application Data
(60) Provisional application No. 62/945,497, filed on Dec. 9, 2019.

(51) Int. Cl. B01J 20/34; B01J 20/20; B01J 20/28

(52) U.S. Cl. CPC B01J 20/3416; B01J 20/28016; B01J 20/28004; B01J 20/20

(57) ABSTRACT

Systems and methods for the destruction of contaminants adsorbed from contaminated water by activated carbon are contemplated. Following adsorption of contaminants onto micron-sized activated carbon particles, the micron-sized activated carbon particles are contained within a reactor. A destructive process is then initiated within the regeneration reaction in order to destroy contaminant adsorbed to the micron-sized activated carbon particles contained within the reactor, which results in the destruction of the contaminants adsorbed to the micron-sized activated carbon particles and thus the regeneration of the micron-sized activated carbon particles for subsequent re-use in remediation of contaminated water.

### CROSS-REFERENCE TO RELATED APPLICATIONS

This application relates to and claims the benefit of U.S. Provisional Application No. 62/945,497 filed Dec. 9, 2019 and entitled “METHODS FOR THE DESTRUCTION OF CONTAMINANTS ADSORBED TO ACTIVATED CARBON,” the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present disclosure relates generally to the field of remediation of contaminated water. More particularly, the present disclosure relates to improved systems and methods for destruction of contaminants adsorbed from contaminated water by activated carbon.

### 2. Related Art

Pollution in soil and groundwater stemming from industrial compounds is a vast problem. Common contaminants can include petroleum-based compounds such as fuels and benzene, as well as industrial solvents such as chlorinated hydrocarbons, pesticides, fertilizers, etc. The excessive use, improper handling, and improper storage of these types of compounds can result in spills and leaching into soil and groundwater.

Over the past few decades, many methods have been developed to remove contaminants from water. Activated carbon is often employed to remove organic chemicals from water through the process of adsorption where the chemicals of concern bind to sorption sites throughout the carbon particle. The most common practice utilizing activated carbon is to pump the water to be treated through vessels holding granular activated carbon particles (GAC, defined as >300 microns in size) to filter the organic chemicals from the incoming water stream. Powdered activated carbon (PAC, defined as <177 microns in diameter, 17-37 micron mean diameter) has also been used, albeit less frequently. See, e.g. Ferhan Çeçen, Özgür Aktaş (2011) Activated Carbon for Water and Wastewater Treatment: Integration of Adsorption and Biological Treatment, 388 pages, ISBN: 978-3-527-32471-2, Wiley-VCH.

In any activated carbon filtration system, at some point in time the activated carbon will fail to continue to filter contaminants adequately, due to the available sorption sites becoming saturated with the contaminants, which in many cases are organic chemicals. This activated carbon is then said to be “spent.” Typically, the filter is returned to service via the spent activated carbon being exchanged for new activated carbon, or via the spent activated carbon being “regenerated” through a process that removes the sorbed contaminants from the sorption sites. Generally, the process of regenerating activated carbon involves the spent activated carbon transported off-site to be regenerated or otherwise reactivated by a process that removes the contaminants from the activated carbon, with the particular regenerated process chosen often depending on the identity of the contaminant(s). However, in many instances, the cost of regeneration procedures, in which it may be required to transport of the activated carbon to a remote location suitable for performing such procedures, may represent a substantial portion thereof, and that cost may be so high that regeneration is uneconomical. As a result, the spent activated carbon may instead be disposed of in accordance with regulatory requirements for disposing of hazardous waste. It is thus desirable that there be new and improved methods for the destruction of contaminants adsorbed to activated carbon by processes that, preferably, can be conducted in conjunction with the adsorption process, or near to the location of contaminated water remediation. This would permit more economical and efficient re-use of activated carbon, or if the activated carbon is to be disposed of, would permit the activated carbon to be disposed of as a non-hazardous material, rather than as a hazardous material.

In the past, there have been certain limited examples of activated carbon water contaminant treatment system wherein a regeneration procedure may be conducted onsite. See., e.g. U.S. Patent Application Publication No. 2019/0046952 A1 (2019) to Cunningham et al.; U.S. Pat. No. 9,073,764 to Conner; U.S. Pat. No. 8,920,644 to Gaid. These systems, called powdered activated carbon treatment (PACT), utilize powdered activated carbon (PAC) in a biological treatment step followed by regeneration of the PAC using a wet air regeneration system. This results in an enhanced ability to recycle the PAC, thereby decreasing disposal volumes and costs. These PACT systems have shown some promise as a water treatment and activated carbon regeneration method, but there remain substantial deficiencies in these systems as well.

It is therefore desirable to have improved systems and methods for treatment of contaminants in water, in which efficiency improvements are provided in both the aspect of contaminant removal and in the aspect of regeneration of spent activated carbon.

### BRIEF SUMMARY

To solve these and other problems, systems and methods for destroying contaminants adsorbed to activated carbon are contemplated. Following adsorption of contaminants onto micron-sized activated carbon particles, the micron-sized activated carbon particles may be contained within a reactor. A destructive process may then be initiated within the regeneration reaction in order to destroy contaminant adsorbed to the micron-sized activated carbon particles contained within the reactor, which may result in the destruction of the contaminants adsorbed to the micron-sized activated carbon particles and thus the regeneration of the micron-sized activated carbon particles for subsequent re-use in remediation of contaminated water.

According to various exemplary embodiments, a method for destroying contaminants adsorbed to activated carbon is contemplated, the method comprising the steps of: concentrating micron-sized activated carbon particles having contaminants adsorbed thereon from a wastewater treatment process; containing the micron-sized activated carbon particles having contaminants adsorbed thereon within a reactor; initiating at least one destructive process operative to destroy at least one contaminant adsorbed to the micron-sized activated carbon particles contained within the reactor; and allowing sufficient time for the at least one destructive process to destroy on at least a portion of the contaminants adsorbed to the micron-sized activated carbon particles.

The contaminant(s) adsorbed to the micron-scale activated carbon particles may be derived from groundwater, industrial wastewater, or municipal water. The contaminants adsorbed to the micron-scale activated carbon particles may also comprise one or more of: a natural organic compound, a synthetic organic compound, a hydrocarbon, a chlorinated hydrocarbon, a fluorinated alkyl substance, a pesticide, a herbicide, a polyaromatic compound, a bacterium, a microorganism, a spore, a virus, or combinations thereof.

The micron-sized activated carbon particles may have a particle size distribution D90 value of less than 15 microns. The micron-sized activated carbon particles may also have a particle size distribution D90 value of less than 5 microns. The micron-sized activated carbon particles may further be mixed with one or more dispersants.

The step of concentrating the micron-sized activated carbon particles may be performed by collecting those particles via or more of: filtration with a ceramic filter, filtration with a microfiltration membrane, filtration with a nano-filtration membrane, filtration with a screen filter, coagulation followed by settling, centrifugation, or combinations thereof. The one or more destructive process may comprise a single destructive process, multiple destructive processes initiated sequentially, or multiple destructive processes initiated concurrently.

The one or more destructive processes may comprise a process that is operative to degrade or destroy at least one target contaminant. The one or more destructive processes may be selected from: biodegradation, smoldering combustion, flaming combustion, electrochemical degradation, oxidative degradation, reductive degradation, thermal-oxidative degradation, ultrasonic degradation, photochemical degradation, photocatalytic degradation, thermal degradation, ultraviolet degradation, plasma degradation, or combinations thereof.

Prior to the step of initiating at least one destructive process operative to destroy at least one contaminant adsorbed to the micron-sized activated carbon particles, one or more additives may additionally be contained within the reactor. The one or more additives may be selected from: a polyelectrolyte, a chelate, a buffer, oxygen, a fire accelerant, a catalyst, an inert reagent, a rheology modifier, a thickening agent, a thinning agent, a polymer, an oxidizing agent, a reducing agent, a surfactant, a mineral, a metal, a bacterium, an electron donor, a carbon source, an electron acceptor, a nutrient, a buffering reagent, a pH modifier, a biocide, sodium hypochlorite, chlorine, chloramine, or combinations thereof.

### DETAILED DESCRIPTION

According to various aspects of the present disclosure, new systems and methods for destroying contaminants adsorbed to activated carbon are contemplated wherein, following adsorption of contaminants onto micron-sized activated carbon particles, the micron-sized activated carbon particles may be contained within a reactor and subsequently exposed to a destruction process may then be initiated within the regeneration reaction in order to destroy the contaminant, thus regenerating of the micron-sized activated carbon particles for subsequent re-use in remediation of contaminated water.

It has been discovered that there may be achieved a significant advantage via using micron-sized activated carbon, sometimes referred to as superfine powdered activated carbon (SPAC, which may have a 1 micron mean diameter) to improve the efficiency of both the adsorption of contaminants by activated carbon, and also the destruction of contaminants adsorbed to the activated carbon particles. It is well established that adsorption kinetics of organic compounds are increased with a decrease in activated carbon particle size. Further, the observed adsorption capacity has also been shown to increase with the decrease in activated carbon particle size. However, what is far less apparent and what may be considered an important aspect of the presently contemplated disclosure, is that the use of smaller sized activated carbon may also result in benefits to the destruction of contaminants adsorbed to the activated carbon.

By using a smaller size of activated carbon, more external surface area of the particle may be exposed, providing closer and faster access between the working mechanism of the destructive process and the adsorbed contaminants, as compared to the use of larger particles of activated carbon. In many cases, a destructive process requires direct contact or close contact between the working mechanism of the process and the contaminant. To achieve this access to the organic compounds bound to sorption sites within the micro-pores of a granular or powdered activated carbon particle requires the organic compounds to diffuse outward into the larger meso-pores, macropores and to the greater aqueous medium. The outward diffusion of a given mass of organic chemical from a given mass of identical activated carbon can be controlled by the size of the activated carbon particle. It thus may be seen that the organic compound diffusion time within a certain activated carbon is governed by the radii of the carbon particle. Therefore, destructive processes that treat compounds sorbed to granular activated carbon are only of limited utility due to the time required for outward diffusion from particles >500 um in diameter. Even the prior art processes described above, which use powdered activated carbon, are not fully sufficient to enable efficient, on-site destruction of sorbed contaminants. However, by decreasing the size by another order of magnitude to the 0.5 to 5 micron range, substantial benefits may be achieved. Through employing smaller particles of activated carbon, more rapid remediation of the activated carbon medium may be achieved, due to more rapid outwardly diffusion of bound organic compound mass, in order to allow an increased velocity of proximal contact (or near contact) with the working mechanism of the destruction process for a given quantity of activated carbon, relative to prior art systems and methods.

The targeted contaminants for adsorption and subsequent destruction may be derived from any source of water that has been contaminated, with exemplary embodiments including but not limited to groundwater, industrial wastewater, municipal water, or drinking water. The target contaminants include organic contaminants that have an affinity for activated carbon. Examples include but are not limited to natural organic compounds, synthetic organic compounds, hydrocarbons, halogenated hydrocarbons including per- and polyfluoroalkyl substances (PFAS) and chlorinated solvents, pesticides, herbicides, energetics, micropollutants, bacteria, microorganisms, spores, viruses, and combinations thereof.

The activated carbon used in the present disclosure can be derived from any source of raw material, with exemplary materials including but not limited to coconut, wood, bamboo, lignite, and coal. The key characteristic of the activated carbon in this composition is its particle size distribution. Particle size distributions are commonly measured via particle size analysis, an analytical technique in which the distribution of sizes of a solid or liquid particulate material is measured. Techniques for particle size analysis may include sieve analysis, direct optical imaging, and laser diffraction. Data from sieve analysis, the oldest of these techniques, is typically presented in the form of an S-curve of cumulative mass retained on each sieve versus the sieve mesh size.

The most commonly used metric when describing particle size distribution are D-values. D-values can be thought of as the cutoff point for the diameter that divides the sample mass into a specified percentage when the particles are arranged on an ascending mass basis. Thus, the D10, D50, and D90 value are the intercept points on the S-curve for 10%, 50%, and 90% of the cumulative mass respectively. D10 is the diameter size at which 10% of the sample's mass are comprised of particles with a diameter less than this size, D50 is the diameter size at which 50% of the sample's mass are comprised of particles with a diameter less than this size, and D90 is the diameter size at which 90% of the sample's mass are comprised of particles with a diameter less than this size. Because D-values are well-established, more advanced methods of measuring particle size distribution than sieve analysis may also report in D-values.

According to exemplary embodiments of the present disclosure the activated carbon component may have a D90 value of less than 15 microns, which means that 90% of the mass of the activated carbon is comprised of particles having a diameter (i.e. the largest dimension) of less than 15 microns. More preferably, the activated carbon has a D90 of less than 5 microns. This disclosure differs from existing systems that use powdered activated carbon (PAC), defined as activated carbon particles less than 177 microns. In practicality, commercially available PAC is less than 44 microns in size with the majority being approximately 20 microns or larger, and less than 10% of the PAC is typically 5 microns or less.

According to other refinements of embodiments of the present disclosure, the micron-scale activated carbon may also be stabilized with a dispersant or mixture of dispersants that acts to maximize the advantage of using the small activated carbon by limiting its re-agglomeration during manufacturing, transport and use. This benefit has been established for the use of particulate activated carbon to treat soil and groundwater in situ. The dispersant can be chosen from polymers or surfactants that are charged or neutral. Examples may include, without limitation, carboxymethyl cellulose, polyacrylic acid, lignosulfonate, polydiallyldimethylammonium chloride, alkyl carboxylates, alkyl and aryl sulfates, alkyl polyethylene oxides, ethylene oxides, and combinations thereof.

According to one exemplary embodiment of the presently contemplated method, it is contemplated that a contaminated water source may be purified by use of a system that allows micron-scale activated carbon to contact a source of contaminated water. Once the adsorption is complete and the activated carbon is deemed to be spent, either after a pre-determined residence time has been reached or by measuring the extent of adsorption by analytical methods, the activated carbon is concentrated using a mechanism that is known to concentrate the micron-scale activated carbon. This mechanism for collection may be, for example but without limitation, ceramic filters, membranes, coagulation followed by settling, centrifugation, or any other mechanism that can sufficiently remove the activated carbon from the stream of now clean water. This mechanism can reside at the end of the adsorption process unit or units, or this may be an additional unit consisting solely for this purpose or separation. The activated carbon along with any residual water removed in this process is then collected in another, which may be the reactor, or another vessel prior to the transfer of the spent activated carbon to the ultimate regeneration reaction where the destructive process is to be applied. Once a target volume of spent activated carbon is collected, further processing can be conducted to prepare the spent carbon for the destructive process, or the destructive process can be applied without further processing. An example of further processing could be de-watering the spent activated carbon to a target water content level.

According to certain embodiments, the reactor may be a separate vessel or container into which the activated carbon is placed following concentration from the source of contaminated water. However, in other embodiments, the reactor may be the same structure (or a subcomponent thereof) that the activated carbon is housed in during the process of adsorbing contaminants from the contaminated water, with the concentration of the activated carbon from the water source being performed via, for example, diversion of the water source, temporary cessation of flow of the water source to the activated carbon, removal of the housing containing the activated carbon, etc. For example, it may be that the reactor is a removable subcomponent of the contaminant removal system that may be removed from that system, along with the activated carbon contained therein, for subsequent performance of the destructive process. The reactor may be at or near to the actual site of contamination, or may be remote from the site of contamination, or may be transported at or to specific locations. The reactor may also be configured, in conjugation with the actual destructive process utilized, to regenerate the activated carbon so that it is suitable for use again in the removal of contaminants from contaminated water, or may be configured for the conversion of the activated carbon from hazardous waste to non-hazardous waste.

The exemplary method allows the contaminants adsorbed to the micron-scale activated carbon to then be destroyed within the reactor by any method that is known to destroy or degrade the target contaminant or contaminants. For example, and without limitation, such destruction methods may include biodegradation, smoldering combustion, flaming combustion, electrochemical degradation, oxidative degradation, thermal-oxidative degradation, ultrasonic degradation, photochemical degradation, photocatalytic degradation, thermal degradation, ultraviolet degradation, plasma degradation, or combinations thereof. These destruction methods may be used sequentially or in combination, assuming the processes are compatible.

In addition, it is also contemplated that additives that assist with the destructive process may be included within the reactor during the performance of the destructive process. In some cases the additives may be required for the destructive process to work, and in other cases the additives improve the effectiveness destructive process. Many additives are envisioned, which may or may not be selected or dependent upon the specific destructive process. For example, and without limitation, contemplated additives may be selected from: polyelectrolytes, chelates, buffers, oxygen, heat, inert reagents, rheology modifiers, thickening agents, thinning agents, polymers, oxidizing agents, reducing agents, surfactants, minerals, metals, bacteria, electron donors, carbon sources, electron acceptors, nutrients, buffering reagents, pH modifiers, biocides, bleach, chlorine, chloramine, and combinations thereof. In some instances, these additives can be included prior to initiating the destructive process or after initiating the destructive process, and they may require replenishment as the destructive process proceeds or following the performance of the destructive process. In other instances, however, such as when the additives may be, for example, a catalyst, the additive may not require replenishment.

The destructive process is subsequently allowed to proceed until sufficient destruction of the target contaminant(s) is achieved. This may be either after a pre-determined time has been reached, or by estimating, modeling, measuring (via direct or indirect methods of measurement) or otherwise determining the extent of destruction. The timeframe of the destructive process treatment will depend on the destructive process(es) utilized, the identity, quantity, or presence of any additives, the particular parameters of the micron-sized activated carbon, and the identity and extent of the contaminant(s) sorbed, but may range from seconds to months. Once the destruction is deemed complete, the activated carbon may then be disposed of or can be considered regenerated for reuse.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the exemplary embodiments.

What is claimed is:

1. A method for destroying contaminants adsorbed to activated carbon, the method comprising the steps of:
a. concentrating micron-sized activated carbon particles having contaminants adsorbed thereon from a wastewater treatment process;
b. containing the micron-sized activated carbon particles having contaminants adsorbed thereon within a reactor;
c. initiating at least one destructive process operative to destroy at least one contaminant adsorbed to the micron-sized activated carbon particles contained within the reactor; and
d. allowing sufficient time for the at least one destructive process to destroy on at least a portion of the contaminants adsorbed to the micron-sized activated carbon particles.

2. The method of claim 1, wherein the contaminant(s) adsorbed to the micron-scale activated carbon particles are derived from groundwater, industrial wastewater, or municipal water.

3. The method of claim 1, wherein the contaminants adsorbed to the micron-scale activated carbon particles comprise one or more of: a hydrocarbon, a chlorinated hydrocarbon, a fluorinated alkyl, a pesticide, a herbicide, a polyaromatic compound, a bacterium, a microorganism, a spore, a virus, or combinations thereof.

4. The method of claim 1, wherein the micron-sized activated carbon particles have a particle size distribution D90 value of less than 15 microns.

5. The method of claim 1, wherein the micron-sized activated carbon particles have a particle size distribution D90 value of less than 5 microns.

6. The method of claim 1, wherein the micron-sized activated carbon particles are mixed with one or more dispersants.

7. The method of claim 1, wherein the concentrating step is performed by collecting the micron-sized activated carbon particles via one or more of: filtration with a ceramic filter, filtration with a microfiltration membrane, filtration with a nano-filtration membrane, filtration with a screen filter, centrifugation, coagulation followed by settling, or combinations thereof.

8. The method of claim 1, wherein the one or more destructive process comprises a single destructive process.

9. The method of claim 1, wherein the one or more destructive process comprises multiple destructive processes initiated sequentially.

10. The method of claim 1, wherein the one or more destructive process comprise multiple destructive processes initiated concurrently.

11. The method of claim 1, wherein the one or more destructive processes comprise a process that is operative to degrade or destroy at least one target contaminant.

12. The method of claim 11, wherein the one or more destructive processes are selected from: biodegradation, smoldering combustion, flaming combustion, electrochemical degradation, oxidative degradation, reductive degradation, thermal-oxidative degradation, ultrasonic degradation, photochemical degradation, photocatalytic degradation, thermal degradation, ultraviolet degradation, plasma degradation, or combinations thereof.

13. The method of claim 1, wherein prior to the step of initiating at least one destructive process operative to destroy at least one contaminant adsorbed to the micron-sized activated carbon particles, one or more additives are additionally contained within the reactor.

14. The method of claim 13, wherein the one or more additives are selected from:
a polyelectrolyte, a chelate, a buffer, oxygen, a fire accelerant, a catalyst, an inert reagent, a rheology modifier, a thickening agent, a thinning agent, a polymer, an oxidizing agent, a reducing agent, a surfactant, a mineral, a metal, a bacterium, an electron donor, a carbon source, an electron acceptor, a nutrient, a buffering reagent, a pH modifier, a biocide, sodium hypochlorite, chlorine, chloramine, or combinations thereof.

15. A system for destroying contaminants adsorbed to activated carbon, the system comprising a reactor adapted to receive and contain micron-sized activated carbon particles having contaminants adsorbed thereon from a wastewater treatment process, the reaction being operative to have initiated therein at least one destructive process operative to destroy at least one contaminant adsorbed to the micron-sized activated carbon particles contained within the reactor, the reactor being further operative to allow sufficient time for the at least one destructive process to destroy at least a portion of the contaminants adsorbed to the micron-sized activated carbon particle following initiation.
